(19) United States
(12) Patent Application Publication
(10) Pub. No.: US 2021/0245777 A1
(43) Pub. Date: Aug. 12, 2021

(54) MAP GENERATION DEVICE, MAP GENERATION SYSTEM, MAP GENERATION METHOD, AND STORAGE MEDIUM

(71) Applicant: HONDA MOTOR CO., LTD., Tokyo (JP)

(72) Inventor: Naoki Mori, Wako-shi (JP)

(21) Appl. No.: 17/151,802

(22) Filed: Jan. 19, 2021

(30) Foreign Application Priority Data
Feb. 12, 2020 (JP) 2020-021406

(51) Int. Cl. B60W 60/00; G01C 21/00; G06K 9/00

(52) U.S. Cl. CPC B60W 60/001; G01C 21/3819; B60W 2420/403; G01C 21/3837; G06K 9/00805; G01C 21/3822

(57) ABSTRACT

A map generation device includes a storage device that stores a program, and a hardware processor. The hardware processor executes the program stored in the storage device to acquire position information of a target outside a vehicle from an external sensor mounted on the vehicle, acquire a first movement amount of the vehicle based on the position information of the target, acquire a second movement amount of the vehicle based on odometry information of the vehicle, and generate map information on a location, where the vehicle has traveled, based on the position information of the target, the first movement amount, and the second movement amount.

### CROSS-REFERENCE TO RELATED APPLICATION

Priority is claimed on Japanese Patent Application No. 2020-021406, filed Feb. 12, 2020, the content of which is incorporated herein by reference.

### BACKGROUND

### Field of the Invention

The present invention relates to a map generation device, a map generation system, a map generation method, and a storage medium.

### Description of Related Art

An invention has been disclosed in which a road map generation system collects camera image data, which is obtained by imaging a road on which a vehicle is traveling, from a plurality of vehicles each provided with an in-vehicle camera and generates road map data based on the collected camera image data (Japanese Unexamined Patent Application, First Publication No. 2019-109293).

However, some inventions using odometry information have been disclosed. For example, an invention has been disclosed in which a chamfer distance between a first feature image obtained by extracting features from a camera image captured by a camera mounted on a vehicle and a second feature image obtained by projecting a target in a map onto the camera image based on a three-dimensional map and a prediction value of a camera orientation is calculated, and is optimized based on epipolar geometry and the odometry information, thereby estimating the camera orientation (Japanese Unexamined Patent Application, First Publication No. 2018-197744).

Furthermore, an invention has been disclosed in which in an autonomously moving robot device, a difference between a travelling direction change calculated from odometry information and a travelling direction change calculated from a measurement result from a gyro sensor, a camera and the like is calculated, thereby estimating a travelling direction change due to carpet drift (Japanese National Publication of International Patent Application No. 2015-521760).

### SUMMARY

In the technology disclosed in Patent Literature 1, there is a case where it is not possible to appropriately exclude an influence of a measurement error of an external sensor and the accuracy of a map is not sufficient. The technologies disclosed in Patent Literatures 2 and 3 are not invented from the viewpoint of generating a map.

The present invention is achieved in view of the problems described above, and one object of the present invention is to provide a map generation device, a map generation system, a map generation method, and a storage medium, by which it is possible to generate a map with higher accuracy.

A map generation device, a map generation system, a map generation method, and a storage medium according to the invention employ the following configurations.

(1) A map generation device according to an aspect of the invention includes a storage device that stores a program, and a hardware processor, wherein the hardware processor is configured to execute the program stored in the storage device to: acquire position information of a target outside a vehicle from an external sensor mounted on the vehicle; acquire a first movement amount of the vehicle based on the position information of the target; acquire a second movement amount of the vehicle based on odometry information of the vehicle, and generate map information on a location, where the vehicle has traveled, based on the position information of the target, the first movement amount, and the second movement amount.

(2) In the aspect (1), the hardware processor is configured to generate a plurality of pieces of first map information by deriving a third movement amount of the vehicle based on the first movement amount and the second movement amount, and combining the position information of the target acquired at a plurality of time points by using the third movement amount.

(3) In the aspect (2), the hardware processor is configured to determine a degree to which each of the first movement amount and the second movement amount is reflected in the third movement amount, based on at least information indicating an accuracy of the first movement amount.

(4) In the aspect (2), the hardware processor is configured to set a first probability distribution, which is a probability distribution of the first movement amount, and a second probability distribution, which is a probability distribution of the second movement amount, and the hardware processor is configured to derive the third movement amount based on a height of a peak of the first probability distribution and a height of a peak of the second probability distribution.

(5) In the aspect (2), the hardware processor is configured to set a first probability distribution, which is a probability distribution of the first movement amount, and a second probability distribution, which is a probability distribution of the second movement amount, and the hardware processor is configured to derive the third movement amount based on a variance of the first probability distribution and a variance of the second probability distribution.

(6) In the aspect (2), the hardware processor is configured to generate second map information by joining a plurality of pieces of first map information, which are acquired adjacent to each other in time series, such that position information of a target included in each of the plurality of pieces of first map information matches.

(7) In the aspect (6), the hardware processor is configured to correct a joining relationship between the plurality of pieces of first map information such that the second map information satisfies a predetermined constraint condition.

(8) In the aspect (7), the hardware processor is configured to change an amount of correction of the first map information based on a reliability of the first map information when correcting the joining relationship between the plurality of pieces of first map information.

(9) A map generation system including the map generation device according to any one of aspects 1 to 8, the external sensor, and a device for acquiring odometry information of the vehicle.

(10) A map generation method according to another aspect of the present invention includes: acquiring, by a computer, position information of a target located outside a vehicle from an external sensor mounted on the vehicle; acquiring, by the computer, a first movement amount of the vehicle based on the position information of the target; acquiring, by the computer, a second movement amount of the vehicle based on odometry information of the vehicle; and generating, by the computer, map information on a location, where the vehicle has traveled, based on the position information of the target, the first movement amount, and the second movement amount.

(11) A non-primary computer readable storage medium according to another aspect of the present invention is storage medium storing a program causing a computer to: acquire position information of a target outside a vehicle from an external sensor mounted on the vehicle; acquire a first movement amount of the vehicle based on the position information of the target; acquire a second movement amount of the vehicle based on odometry information of the vehicle; and generate map information on a location, where the vehicle has traveled, based on the position information of the target, the first movement amount, and the second movement amount.

According to (1) to (12), it is possible to generate a map with higher accuracy.

### BRIEF DESCRIPTION OF THE DRAWINGS

FIG. 1 is a diagram showing a configuration example of a map generation system according to a first embodiment.

FIG. 2 is a diagram showing an example of a configuration of a map generation device.

FIG. 3 is a diagram schematically showing details of a process performed by a third probability distribution derivation part.

FIG. 4 is a diagram schematically showing details of a process performed by a partial map generator.

FIG. 5 is a diagram schematically showing details of a process performed by a partial map joining processor.

FIG. 6 is a diagram showing how a corrector corrects primary generation map information based on the primary generation map information itself.

FIG. 7 is a diagram showing how the corrector corrects the primary generation map information based on reference map information.

FIG. 8 is a diagram schematically showing details of a correction process performed by the corrector.

FIG. 9 is a diagram showing a configuration example of a map generation system according to a second embodiment.

### DESCRIPTION OF EMBODIMENTS

Hereinafter, embodiments of a map generation device, a map generation system, a map generation method, and a storage medium of the present invention will be described with reference to the drawings.

### First Embodiment

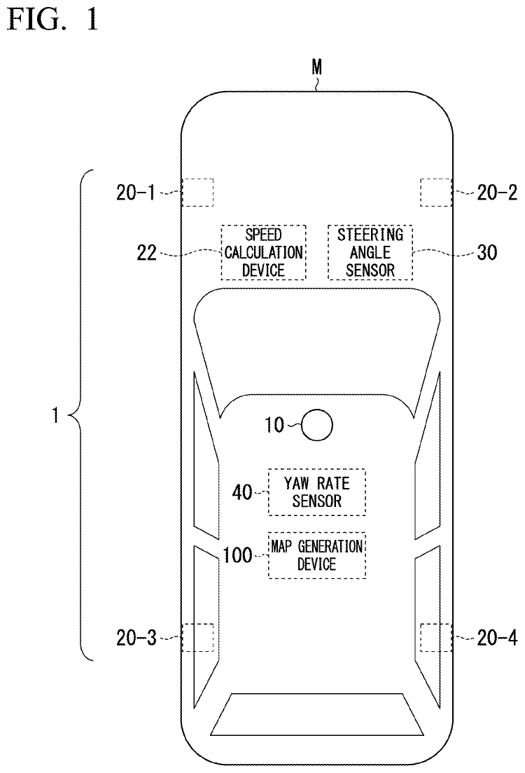

FIG. 1 is a diagram showing a configuration example of a map generation system 1 according to the first embodiment. The map generation system 1 is mounted on a vehicle, and includes, for example, a light detection and ranging (LIDAR) 10, which is an example of an external sensor, wheel speed sensors 20-1 to 20-4, which are an example of a device for acquiring odometry information, a speed calculation device 22, a steering angle sensor 30, a yaw rate sensor 40, and a map generation device 100. A vehicle M may be a vehicle having an automatic driving function or a vehicle that travels by manual driving. Furthermore, there is no special limitation in a driving mechanism of the vehicle M, and various vehicles such as an engine vehicle, a hybrid vehicle, an electric vehicle, and a fuel cell vehicle may be the vehicle M. Hereinafter, when the respective wheel speed sensors are not distinguished from one another, they are simply referred to as wheel speed sensors 20.

The odometry information refers to a result obtained by estimating the position and orientation of a moving body based on an output value of a device (typically, a sensor) attached to the moving body in order to measure the behavior of the moving body. In the case of a vehicle, some or all of the wheel speed sensors 20 for measuring wheel speeds, the speed calculation device 22 that calculates the speed of the vehicle based on the output of the wheel speed sensors 20, the steering angle sensor 30 that detects an operation angle (or an angle of a steering mechanism) of a steering wheel, and the yaw rate sensor 40 that detects a rotation speed around a vertical axis generated in the vehicle, other sensors similar to these, and the like correspond to the aforementioned “sensor”. As a sensor for acquiring the speed, a sensor that detects a rotation angle of a transmission or a traveling motor may be used.

The LIDAR 10 emits light to detect reflected light, and detects a distance to an object by measuring the time from the emission to the detection. The LIDAR 10 can change the light emission direction for both an elevation angle or a depression angle (hereinafter, an emission direction ϕ in a vertical direction) and an azimuth angle (an emission direction θ in a horizontal direction). The LIDAR 10 repeats, for example, an operation of fixing the emission direction ϕ and performing scanning while changing the emission direction θ, changing the emission direction ϕ in the vertical direction, and then fixing the emission direction ϕ at the changed angle and performing scanning while changing the emission direction θ. Hereinafter, the emission direction ϕ is referred to as a “layer”, one-time scanning performed while changing the emission direction θ after fixing the layer is referred to as a “line scan”, and broadly performing the line scan for all layers is referred to as a “1 scan”.

The LIDAR 10 outputs, for example, a data set (LIDAR data), which uses {ϕ, θ, d, p} as one unit, to the map generation device 100 and the like. d denotes a distance and p denotes the intensity of reflected light. In FIG. 1, the LIDAR 10 is installed on a roof of the vehicle M and can change the emission direction θ by 360°, but this arrangement is merely an example. For example, a LIDAR, which is provided at a front part of the vehicle M and can change the emission direction θ by 180° around the front of the vehicle M, and a LIDAR, which is provided at a rear part of the vehicle M and can change the emission direction θ by 180° around the rear of the vehicle M, may be mounted on the vehicle M.

The wheel speed sensors 20 are attached to respective wheels of the vehicle M and output pulse signals each time the wheels rotate by a predetermined angle. The speed calculation device 22 calculates speeds Vw-1 to Vw-4 of the wheels by counting the pulse signals input from the wheel speed sensors 20. Furthermore, the speed calculation device 22 calculates the speed V_{M} of the vehicle M by averaging the speeds of driven wheels among the speeds Vw-1 to Vw-4 of the wheels, for example.

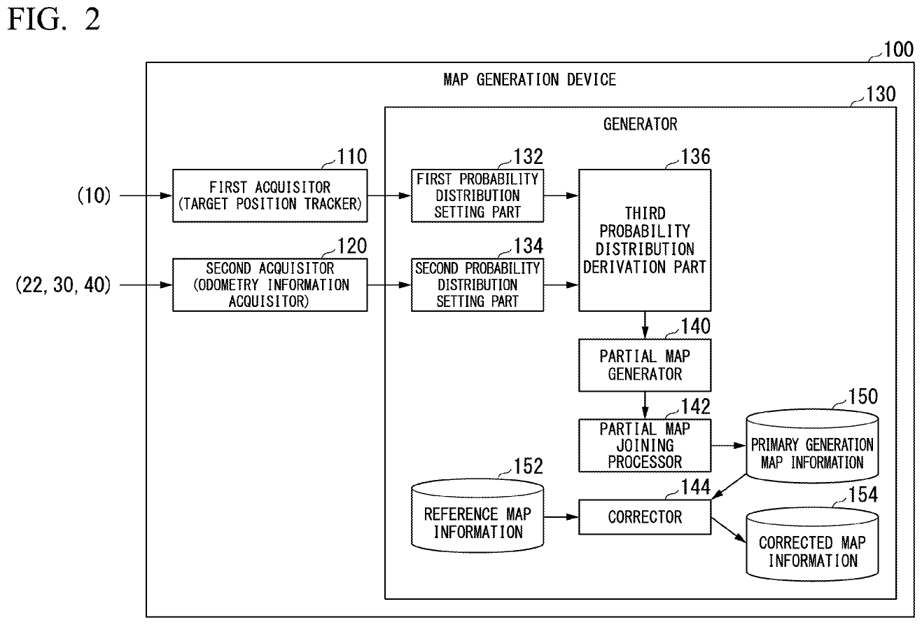

FIG. 2 is a diagram showing an example of a configuration of the map generation device 100. The map generation device 100 includes, for example, a first acquisitor (target position tracker) 110, a second acquisitor (odometry information acquisitor) 120, and a generator 130. The generator 130 includes, for example, a first probability distribution setting part 132, a second probability distribution setting part 134, a third probability distribution derivation part 136, a partial map generator 140, a partial map joining processor 142, and a corrector 144. These components are implemented by, for example, a hardware processor such as a central processor (CPU) that executes a program (software). Some or all of these components may be implemented by hardware (a circuit unit: including circuitry) such as a large scale integration (LSI), an application specific integrated circuit (ASIC), a field-programmable gate array (FPGA), and a graphics processor (GPU), or may be implemented by software and hardware in cooperation. The program may be stored in advance in a storage device (storage device including a non-primary storage medium) such as an HDD and a flash memory, or may be installed when a detachable storage medium (non-primary storage medium) storing the program, such as a DVD and a CD-ROM, is mounted on a drive device.

Furthermore, the map generation device 100 writes information such as primary generation map information 150, reference map information 152, and corrected map information 154 in the storage device such as an HDD, an RAM, and a flash memory, or holds the information in advance. The reference map information 152 does not necessarily have to be held inside the map generation device 100 or by a storage device mounted on the vehicle M. Alternatively, the reference map information 152 may be held by a storage device outside the map generation device 100 or the vehicle M and the map generation device 100 may appropriately acquire the reference map information 152 by communication.

The first acquisitor 110 acquires position information of a target located outside the vehicle M from an external sensor such as the LIDAR 10 mounted on the vehicle M. For example, the first acquisitor 110 collects a data set (LIDAR data) input from the LIDAR 10 for each 1 scan and acquires point cloud data. The point cloud data is three-dimensional data representing the position of the target around the vehicle M. The point cloud data is not just a set of reflection points, and may include data of a model representing a surface or a three-dimensional object after the object is recognized as constituting an object having a spread such as a “road surface” and a “guiderail”.

Furthermore, the point cloud data includes the intensity of reflected light, and the outline of road marking lines (white lines or yellow lines) on the road surface can be extracted based on an intensity difference from surrounding data. The object recognition may be performed by a built-in computer of the LIDAR 10 or an object recognition device attached to the LIDAR 10, or may be performed by the first acquisitor 110.

Moreover, the first acquisitor 110 compares a current value and a previous value (may be a value several times previously) of point cloud data acquired in time series, and derives and acquires a movement amount (first movement amount) of the vehicle M per cycle. One cycle means a period between the start time and the end time for deriving the movement amount of the vehicle M. One cycle is, for example, a period of about 0.1 [sec] to about 1 [sec]. For example, assuming that an orthogonal coordinate system assumed by the map generation device 100 has XYZ axes, the movement amount is a movement amount with six degrees of freedom including a translational movement amount for each of the XYZ axes and a rotational movement amount about each of the XYZ axes. For example, the first acquisitor 110 arbitrarily moves the current point cloud data within six degrees of freedom, and derives a movement amount when the matching rate with the previous point cloud data is highest, as a movement amount per cycle of the relevant time. The first acquisitor 110 provides the generator with information indicating the accuracy of matching of the point cloud data. The accuracy of matching of the point cloud data is an example of the accuracy of the movement amount of the vehicle M based on the point cloud data. The accuracy of matching is determined by the first acquisitor 110 such that the higher the matching rate, the higher the accuracy.

The second acquisitor 120 acquires output values of the speed calculation device 22, the steering angle sensor 30, and the yaw rate sensor 40, and synthesizes the acquired output values to acquire the odometry information of the vehicle M. The odometry information may be information represented by the movement amount with six degrees of freedom, like the movement amount derived by the first acquisitor 110, or may be, in practice, a movement amount with three degrees of freedom including a translational movement amount for each of the XY axes and a rotational movement amount about the Z axis. The odometry information is an example of a second movement amount. In the following description, it is assumed that the odometry information is the movement amount with three degrees of freedom and a translational movement amount for the Z axis and a rotational movement amount about each of the XY axes are set to zero. Various methods are known as calculation methods for acquiring the odometry information, but as an example, a calculation method called a Unicycle model may be adopted. In this calculation method, for example, the output value of the speed calculation device 22 and the output value of the steering angle sensor 30 are used as input values. The odometry information that is output is, for example, a position x(t) in an X direction, a position y(t) in a Y direction, and an azimuth th(t) of the vehicle M at the time t. When it is assumed that the output value of the speed calculation device 22 is v(t) and the output value of the steering angle sensor 30 is d(t) at the time t, a slip angle (angle formed between the direction of the vehicle M and an actual travelling direction) of the vehicle M is defined as B(t) as an intermediate coefficient, the length from the center of gravity to the center between front wheels of the vehicle M is Lf, and the length from the center of gravity to the center between rear wheels of the vehicle M is Lr, the odometry information is derived based on the following formulas (A) to (D).

x(t+1)=x(t)+v(t)×cos(th(t)+B(t))×Δt (A)

y(t+1)=y(t)+v(t)×sin(th(t)+B(t))×Δt (B)

th(t+1)=th(t)+v(t)/Lr×sin(B(t))×Δt (C)

B(t)=atan[{Lr/(Lf+Lr)}×tan(d(t))] (D)

The generator 130 generates a map based on the movement amount of the vehicle M acquired by the first acquisitor 110 and the odometry information.

The first probability distribution setting part 132 of the generator 130 sets a first probability distribution for the movement amount of the vehicle M acquired by the first acquisitor 110. The first probability distribution is obtained, for example, every six degrees of freedom. The first probability distribution setting part 132 sets the movement amount of the vehicle M acquired by the first acquisitor 110 as a position of a peak, and sets the first probability distribution such that the higher the accuracy of matching, the smaller the variance and the higher the position of the peak. The first probability distribution, a second probability distribution, and a third probability distribution to be described below are set in the form of a normal distribution, for example, but are not limited thereto and may be set in a form other than the normal distribution.

The second probability distribution setting part 134 sets a second probability distribution based on the odometry information acquired by the second acquisitor 120. The second probability distribution is obtained, for example, every six degrees of freedom. The second probability distribution setting part 134 sets, as a position of a peak, the movement amount of the vehicle M obtained from the odometry information. The second probability distribution setting part 134 may set a variance of the second probability distribution and a height of a peak as fixed values or variable values. In the latter case, for example, when the vehicle M is almost going straight, the second probability distribution setting part 134 may decrease the variance and/or increase the height of the peak because the reliability of the odometry information is high, and when the vehicle M is turning, the second probability distribution setting part 134 may increase the variance and/or decrease the height of the peak because the reliability of the odometry information is low.

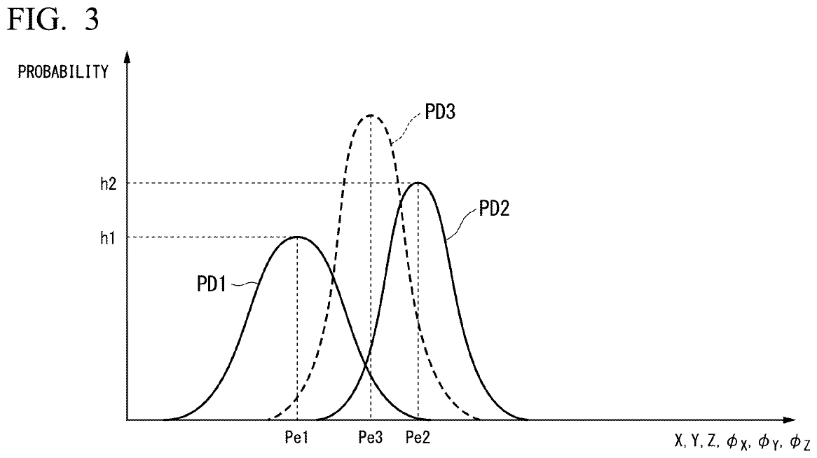

The third probability distribution derivation part 136 derives a third probability distribution by fusing the first probability distribution and the second probability distribution, for example, every six degrees of freedom. FIG. 3 is a diagram schematically showing details of a process performed by the third probability distribution derivation part 136. The third probability distribution derivation part 136 derives a third probability distribution PD3 by, for example, shifting a first probability distribution PD1 and a second probability distribution PD2 to predetermined peak positions and adding them. Here, assuming that a position of a peak and a variance of the first probability distribution PD1 are Pe1 and V1 and a position of a peak and a variance of the second probability distribution PD2 are Pe2 and V2, the third probability distribution derivation part 136 derives a position Pe3 (third movement amount) of a peak of the third probability distribution PD3 based on, for example, the following formulas (1) and (2). In the formula, Sig { } denotes a sigmoid function.

Pe3=α×Pe1+(1−α)×Pe2 (1)

α=Sig{(V2−V1)/(V1+V2)} (2)

Furthermore, assuming that the position of the peak of the first probability distribution PD1 is Pe1, the height (probability) of the peak Pe1 is h1, the position of the peak of the second probability distribution PD2 is Pe2, and the height (probability) of the peak Pe2 is h2, the third probability distribution derivation part 136 derives the peak Pe3 of the third probability distribution PD3 based on, for example, the following formulas (3) and (4).

Pe3=β×Pe1+(1−β)×Pe2 (3)

β=Sig{(h1−h2)/(h+h2)} (4)

The above α and β are coefficients that determine the degree to which each of the movement amount of the vehicle M based on the point cloud data and the odometry information is reflected on the map. By so doing, based on at least information indicating the accuracy of the movement amount of the vehicle M based on the point cloud data, the third probability distribution derivation part 136 determines the degree to which each of the movement amount of the vehicle M based on the point cloud data and the odometry information is reflected in the position of the peak Pe3 of the third probability distribution PD3.

The third probability distribution derivation part 136 may derive only the position of the peak Pe3 of the third probability distribution PD3 as a solution, or may derive the third probability distribution PD3 also including a height of a peak and a variance as a solution. The position of the peak Pe3 of the third probability distribution PD3 indicates the movement amount of the vehicle M with respect to the corresponding degree of freedom, and the height of the peak and the variance indicate the reliability of the movement amount.

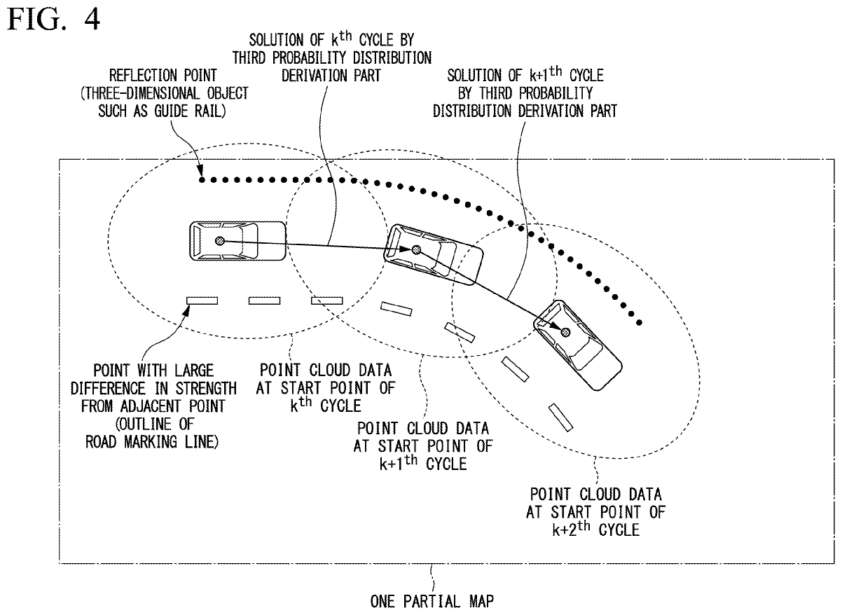

The partial map generator 140 generates partial map information based on the solution (including at least a change in the position and orientation of the vehicle M) derived by the third probability distribution derivation part 136 and point cloud data acquired at the timing corresponding to the solution. FIG. 4 is a diagram schematically showing details of a process performed by the partial map generator 140. FIG. 4 to FIG. 7 are simply represented by a two-dimensional plane, but may actually represent processes in a three-dimensional space. Here, it is not possible to combine point cloud data acquired at different time points in the vehicle M that is moving, without information on a change in the position and orientation of the vehicle M. The partial map generator 140 combines point cloud data of the start point or end point for a predetermined number of cycles based on a change in the position and orientation of the vehicle M, which is included in the solution derived by the third probability distribution derivation part 136, thereby generating partial map information.

For example, when the start point of a k^{th} cycle is used as a reference, the partial map generator 140 generates partial map information by combining the following.

(1) Point cloud data at the start point of the k^{th} cycle

(2) Data obtained by translating and rotating point cloud data at the start point of a k+1^{th} cycle based on a change in the position and orientation of the vehicle M in the k^{th} cycle

(3) Data obtained by translating and rotating point cloud data at the start point of a k+2^{th} cycle based on a change in the position and orientation of the vehicle M in the k^{th} cycle and a change in the position and orientation of the vehicle M in the k+1^{th} cycle

(4) . . . (The same repeats hereinafter)

The “predetermined number”, which is the number of times in which the above process is performed, is, for example, a number to which an influence of sensor drift does not become a significant value. The sensor drift is a steady error component (drift component) that occurs in the external sensor such as the LIDAR 10.

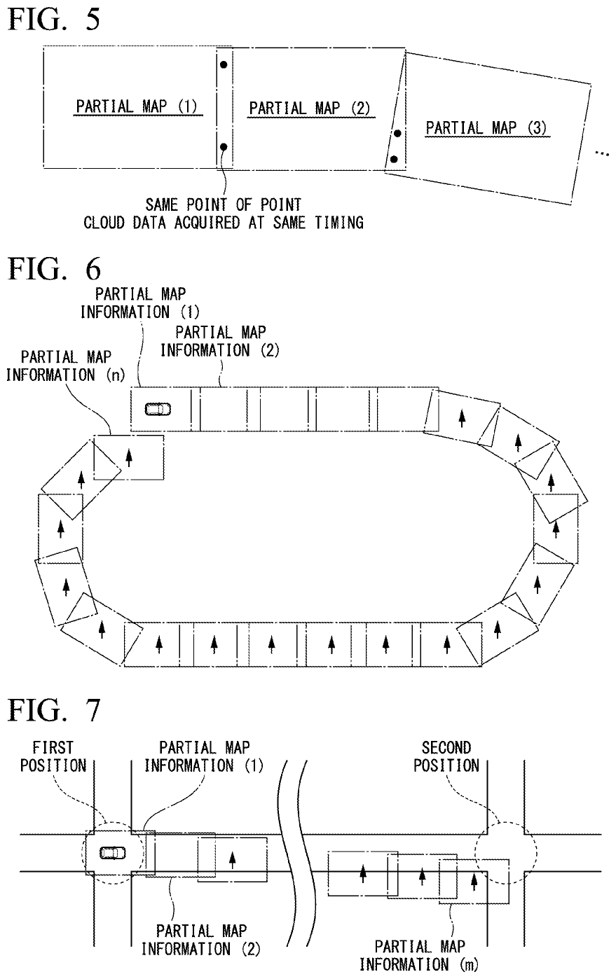

The partial map joining processor 142 joins the partial map information generated by the partial map generator 140, thereby generating the primary generation map information 150. FIG. 5 is a diagram schematically showing details of a process performed by the partial map joining processor 142. The partial map joining processor 142 joins partial map information, which are generated corresponding to the time series, in the order of the time series. At this time, the partial map joining processor 142 provides areas (marginal areas), which overlap each other, to two pieces of partial map information that are directly joined, and joins the two pieces of partial map information such that the same points of point cloud data acquired at the same timing overlap each other in the marginal areas, that is, point cloud data included in respective partial map information match each other (loop closing). By so doing, sequentially joined information is the primary generation map information 150.

The corrector 144 corrects the primary generation map information 150 based on the primary generation map information 150, or by comparing the primary generation map information 150 and the reference map information such that the primary generation map information 150 satisfies a predetermined constraint condition. FIG. 6 and FIG. 7 are diagrams schematically showing details of a process performed by the corrector 144.

FIG. 6 is a diagram showing how the corrector 144 corrects the primary generation map information 150 based on the primary generation map information 150 itself. For example, when the vehicle M travels on a route in which the vehicle M goes around and returns to the original location and partial map information to be finally joined is deviated, the corrector 144 performs a process of gradually correcting the joining between the partial map information (moving or rotating one partial map information with respect to the other) in order to eliminate the deviation. Partial map information (1) and partial map information (n) indicate locations where the vehicle M has gone around and returned to the original positions, and need to be joined originally. Arrows in the drawing indicate the direction in which the partial map information needs to be moved in order to correct the deviation. The corrector 144 roughly determines that the vehicle M has returned to the same location, based on information of, for example, a global positioning system (GPS) and the like, compares point cloud data related to the partial map information (1) and point cloud data related to the partial map information (n), and determines whether the point cloud data indicate the same location based on the matching rate.

FIG. 7 is a diagram showing how the corrector 144 corrects the primary generation map information 150 based on the reference map information 152. For example, when the vehicle M travels on a route for moving from a first position known on the reference map information 152 to a second position known on the same reference map information 152 and a result obtained by joining the partial map information is deviated from the second position, the corrector 144 performs a process of gradually correcting the joining between the partial map information in order to eliminate the deviation. In the example of FIG. 7, it can be seen by the reference map information 152 that the first position and the second position are both intersections and a road between the two intersections is a straight road. In such a case, when it is recognized by point cloud data and the like that the vehicle M has passed through the intersection (first position) and then a road shape, which is indicated by the primary generation map information 150 based on point cloud data acquired until the arrival of the vehicle M to the intersection (second position) is recognized, is curved, the corrector 144 corrects the curve to approach a straight line. In such a case, the corrector 144 may recognize the arrival to the second position based on information of, for example, a global positioning system (GPS) and the like, or extract information corresponding to a “mileage” from odometry information and recognize the arrival to the second position based on the extracted information.

The corrector 144 does not move or rotate (hereinafter, correct) a plurality of pieces of partial map information by the same amount, but may make a correction amount different for each partial map information. For example, based on the reliability of partial map information, the corrector 144 may make the correction amount of partial map information with high reliability smaller than the correction amount of partial map information with low reliability. Here, assuming that adjacent partial map information is corrected in a ripple manner from certain partial map information, the “correction amount” does not include an amount that is corrected by the same amount as the adjacent partial map information is corrected. Hereinafter, this will be described below.

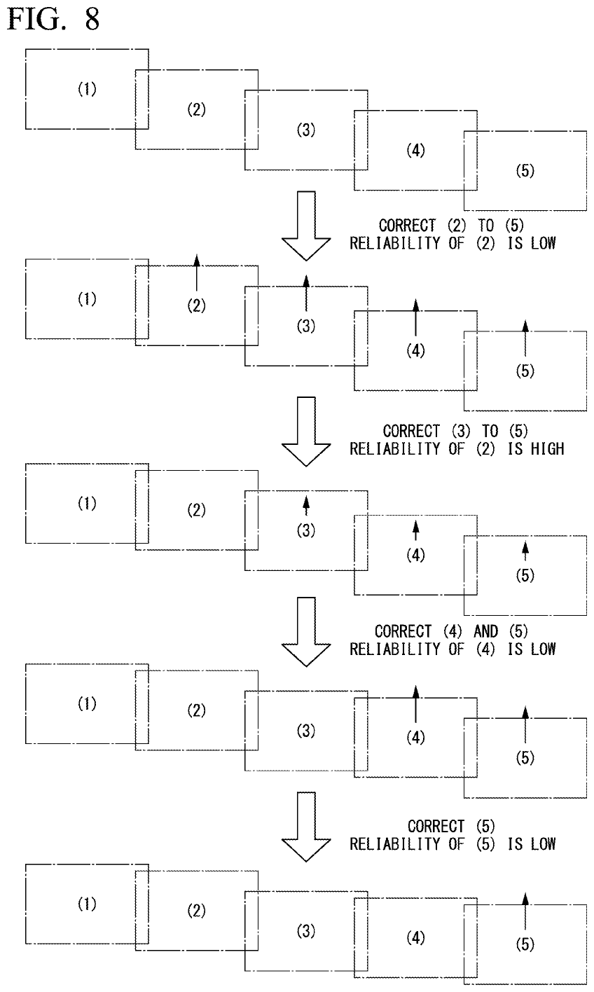

FIG. 8 is a diagram schematically showing details of a correction process performed by the corrector 144. In the drawing, the numbers in parentheses indicate identification information of partial map information. (1) indicates partial map information generated based on initial information regarding the time series, and hereinafter, (2), (3), (4), and (5) indicate partial map information generated based on new information in this order. The corrector 144 corrects the partial map information in a ripple manner in order from the partial map information (1). First, the corrector 144 corrects the position and orientation of the partial map information (2) with respect to the partial map information (1), and corrects the positions and orientations of the partial map information (3) to (5) such that the relative relationship among the partial map information (3) to (5) with respect to the partial map information (2) is not changed. In the example of FIG. 8, since the reliability of the partial map information (2) is relatively low, the amount of correction thereof is relatively large.

Next, the corrector 144 corrects the position and orientation of the partial map information (3) with respect to the partial map information (2), and corrects the positions and orientations of the partial map information (4) and (5) such that the relative relationship between the partial map information (4) and (5) with respect to the partial map information (3) is not changed. In the example of FIG. 8, since the reliability of the partial map information (3) is relatively high, the amount of correction thereof is relatively small.

Next, the corrector 144 corrects the position and orientation of the partial map information (4) with respect to the partial map information (3), and corrects the position and orientation of the partial map information (5) such that the relative relationship of the partial map information (5) with respect to the partial map information (4) is not changed. In the example of FIG. 8, since the reliability of the partial map information (4) is relatively low, the amount of correction thereof is relatively large. Then, the corrector 144 corrects the position and orientation of the partial map information (5) with respect to the partial map information (4). In the example of FIG. 8, since the reliability of the partial map information (5) is relatively low, the amount of correction thereof is relatively large.

As the reliability of the partial map information, for example, it may be possible to use an average value of indexes such as the variance of the third probability distribution PD3 for each cycle included in the partial map and the height of the peak thereof. Furthermore, as the reliability of the partial map information, it may be possible to use an average value of indexes such as the variance of the first probability distribution PD1 or the second probability distribution PD2 and the height of the peak thereof, which is the basis for deriving the third probability distribution PD3 for each cycle included in the partial map information.

In this way, the corrector 144 changes the amount of correction of the partial map information based on the reliability of the partial map information when correcting the joining relationship between the partial map information. With this, the corrected map information 154 can be generated in a form in which partial map information with high reliability is maintained as is as much as possible, so that it is possible to generate a map with high accuracy.

In accordance with the map generation system 1 and the map generation device 100 according to the first embodiment described above, it is possible to generate a map with higher accuracy. In general, an error due to the odometry information fluctuates gently and an error due to the external sensor such as the LIDAR fluctuates greatly, but depending on the state, it has the property that the movement amount of the vehicle M can be derived with higher accuracy than the odometry information. Accordingly, the third probability distribution derivation part 136 derives the movement amount of the vehicle M (the position of the peak in the third probability distribution) based on both of these and the partial map generator 140 generates the partial map information based on the derived movement amount, so that it is possible to generate a map with higher accuracy.

Furthermore, based on at least information indicating the accuracy of the movement amount of the vehicle M based on the point cloud data, the third probability distribution derivation part 136 determines the degree to which each of the movement amount of the vehicle M based on the point cloud data and the odometry information is reflected in the position of the peak Pe3 of the third probability distribution PD3, so that information with good accuracy among the above is reflected in a map more greatly. Therefore, it is possible to generate a map with higher accuracy.

Although the LIDAR has been exemplified as an example of the external sensor, any sensor may be used as the external sensor as long as it can measure a three-dimensional position. Furthermore, a two-dimensional sensor such as a monocular camera may be used as the external sensor as long as information is adopted only in a part of the degree of freedom, or a radar device such as a millimeter-wave radar may be used as the external sensor as long as a low accurate part can be supplemented by another external sensor.

Although the variance and the height of the peak have been exemplified as examples of probability distribution parameters, probability distributions of some or all of the first probability distribution setting part 132, the second probability distribution setting part 134, the third probability distribution derivation part 136 may be set by adjusting skewness, kurtosis and the like.

### Second Embodiment

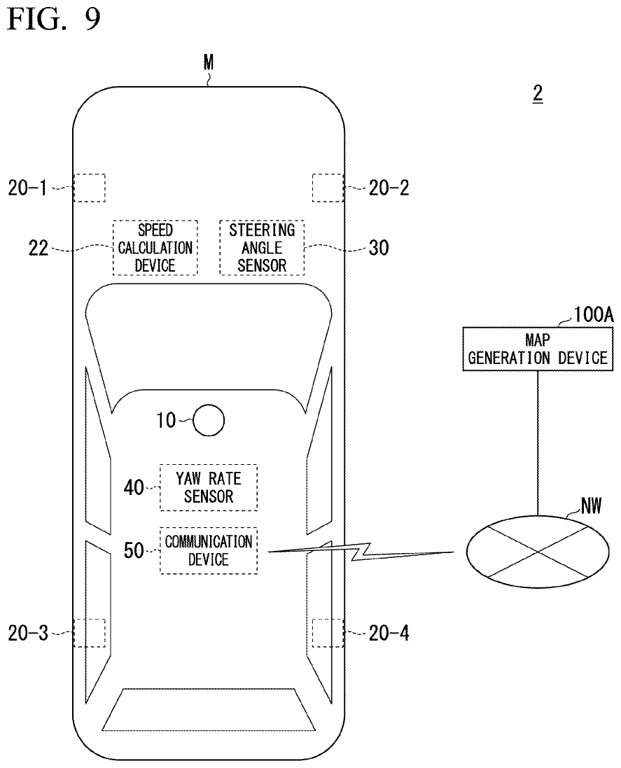

Hereinafter, a second embodiment will be described. FIG. 9 is a diagram showing a configuration example of a map generation system 2 according to the second embodiment. In the map generation system 2, a map generation device 100A is configured as a cloud server other than a vehicle M. One or more vehicles M are provided with a communication device 50 that processes information from the LIDAR 10, the speed calculation device 22, the steering angle sensor 30, the yaw rate sensor 40, and the like as needed, and transmits the processed information to the map generation device 100A. The map generation device 100A acquires information from the communication device 50 via a network NW. The network NW includes, for example, a wide area network (WAN), a local area network (LAN), a cellular network, a radio base station, and the like. The map generation device 100A has the same configuration as that of the first embodiment, except that it includes a communication interface (not shown) for connecting to the network NW (see FIG. 2). This will not be described again.

In accordance with the map generation system 2 and the map generation device 100A according to the second embodiment described above, it is possible to achieve the same effects as those of the first embodiment.

Although a mode for carrying out the present invention has been described using the embodiments, the present invention is not limited to these embodiments and various modifications and substitutions can be made without departing from the spirit of the present invention.

What is claimed is:

1. A map generation device comprising:
a storage device that stores a program; and
a hardware processor,
wherein the hardware processor is configured to execute the program stored in the storage device to:
acquire position information of a target located outside a vehicle from an external sensor mounted on the vehicle;
acquire a first movement amount of the vehicle based on the position information of the target;
acquire a second movement amount of the vehicle based on odometry information of the vehicle; and
generate map information on a location, where the vehicle has traveled, based on the position information of the target, the first movement amount, and the second movement amount.

2. The map generation device according to claim 1, wherein the hardware processor is configured to generate first map information by deriving a third movement amount of the vehicle based on the first movement amount and the second movement amount, and combining the position information of the target acquired at a plurality of time points by using the third movement amount.

3. The map generation device according to claim 2, wherein the hardware processor is configured to determine a degree to which each of the first movement amount and the second movement amount is reflected in the third movement amount, based on at least information indicating an accuracy of the first movement amount.

4. The map generation device according to claim 2,
wherein the hardware processor is configured to set a first probability distribution, which is a probability distribution of the first movement amount, and a second probability distribution, which is a probability distribution of the second movement amount, and
wherein the hardware processor is configured to derive the third movement amount based on a height of a peak of the first probability distribution and a height of a peak of the second probability distribution.

5. The map generation device according to claim 2,
wherein the hardware processor is configured to set a first probability distribution, which is a probability distribution of the first movement amount, and a second probability distribution, which is a probability distribution of the second movement amount, and
wherein the hardware processor is configured to derive the third movement amount based on a variance of the first probability distribution and a variance of the second probability distribution.

6. The map generation device according to claim 2, wherein the hardware processor is configured to generate second map information by joining a plurality of pieces of first map information, which are acquired adjacent to each other in time series, such that position information of a target included in each of the plurality of pieces of first map information matches.

7. The map generation device according to claim 6, wherein the hardware processor is configured to correct a joining relationship between the plurality of pieces of first map information such that the second map information satisfies a predetermined constraint condition.

8. The map generation device according to claim 7, wherein the hardware processor is configured to change an amount of correction of the first map information based on a reliability of the first map information when correcting the joining relationship between the plurality of pieces of first map information.

9. A map generation system comprising:
the map generation device according to claim 1;
the external sensor; and
a device for acquiring odometry information of the vehicle.

10. A map generation method, comprising:
acquiring, by a computer, position information of a target located outside a vehicle from an external sensor mounted on the vehicle;
acquiring, by the computer, a first movement amount of the vehicle based on the position information of the target;
acquiring, by the computer, a second movement amount of the vehicle based on odometry information of the vehicle; and
generating, by the computer, map information on a location, where the vehicle has traveled, based on the position information of the target, the first movement amount, and the second movement amount.

11. A non-primary computer readable storing medium storing a program causing a computer to:
acquire position information of a target located outside a vehicle from an external sensor mounted on the vehicle;
acquire a first movement amount of the vehicle based on the position information of the target;
acquire a second movement amount of the vehicle based on odometry information of the vehicle; and
generate map information on a location, where the vehicle has traveled, based on the position information of the target, the first movement amount, and the second movement amount.
